(19) United States
(12) Patent Application Publication
(10) Pub. No.: US 2026/0281425 A1
(43) Pub. Date: Sep. 17, 2026

(54) Method and Apparatus of Bi-Directional Optical Flow Displacement Fusion for Video Coding

(71) Applicant: MEDIATEK INC., Hsinchu City (TW)

(72) Inventors: Chen-Yen LAI, Hsinchu City (TW); Guan-Hao CHEN, Hsinchu City (TW); Wen-Chun LIN, Hsinchu City (TW); Tzu-Der CHUANG, Hsinchu City (TW); Ching-Yeh CHEN, Hsinchu City (TW); Chih-Wei HSU, Hsinchu City (TW); Yi-Wen CHEN, San Jose, CA (US)

(21) Appl. No.: 19/472,639

(22) PCT Filed: Jul. 25, 2024
(86) PCT No.: PCT/CN2024/107481

§ 371 Date: Oct. 4, 2025

Related U.S. Application Data
(60) Provisional application No. 63/530,550, filed on Aug. 3, 2023.

(51) Int. Cl. H04N 19/577; H04N 19/132; H04N 19/139; H04N 19/176; H04N 19/182; H04N 19/52

(52) U.S. Cl. CPC H04N 19/577; H04N 19/132; H04N 19/139; H04N 19/176; H04N 19/182; H04N 19/52

(57) ABSTRACT

Method and apparatus of bi-directional prediction are disclosed. According to one method of the present invention, sample-based displacements for samples in the current block are determined. A combined displacement is determined for a target sample in the current block by combining derived displacements of multiple samples in a region enclosing the target sample. A bidirectional predictor is determined for the current block based on a first predictor derived from a first reference picture in list0, a second predictor derived from a second reference picture in list1, and a refinement term derived using refinement information comprising the combined displacement. The current block is encoded or decoded by using prediction information comprising the bidirectional predictor. According to another method, both motion displacements have the same sign for the case that both reference pictures are before or after the current picture.

### CROSS REFERENCE TO RELATED APPLICATIONS

The present invention claims priority to U.S. Provisional Patent Application, Ser. No. 63/530,550, filed on Aug. 3, 2023 The U.S. Provisional Patent Application is hereby incorporated by reference in its entirety.

### FIELD OF THE INVENTION

The present invention relates to bi-directional prediction for MV refinement based on BDOF (Bi-Directional Optical Flow).

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Furthermore, various new coding tools (for example, Decoder-Side Motion Vector Refinement (DMVR), Bi-directional Optical Flow (BDOF), and some other coding tools) have been proposed for consideration in the development of a new coding standard beyond the VVC.

### Multi-Pass Decoder-Side Motion Vector Refinement (MP-DMVR)

In ECM-2.0, a Multi-Pass (MP) DMVR method is applied in regular merge mode if the selected merge candidate meets the DMVR conditions. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF).

Similar to the DMVR in VVC, the BM refined a pair of motion vectors MV0 and MV1 under the constrain that MVD0 (MV0′-MV0) is just the opposite sign of MVD1 (MV1′-MV1), as in FIG. 2.

In order to increase the accuracy of the MVs of the merge mode, a bilateral-matching (BM) based decoder side motion vector refinement is applied in VVC. In bi-prediction operation, a refined MV is searched around the initial MVs (232 and 234) in the reference picture list L0 212 and reference picture list L1 214 for a current block 220 the current picture 210. The collocated blocks 222 and 224 in L0 and L1 are determined according to the initial MVs 230 and 232) and the location of the current block 220 in the current picture as shown in FIG. 2. The BM method calculates the distortion between the two candidate blocks (242 and 244) in the reference picture list L0 and list L1. The locations of the two candidate blocks (242 and 244) are determined by adding two opposite offset (262 and 264) to the two initial MVs (232 and 234) to derive the two candidate MVs (252 and 254). The SAD between the candidate blocks (242 and 244) based on each MV candidate around the initial MV (232 or 234) is calculated. The MV candidate (252 or 254) with the lowest SAD becomes the refined MV and used to generate the bi-predicted signal.

### Adaptive Decoder Side Motion Vector Refinement (Adaptive MP-DMVR)

In JVET-X0049 (Han Huang, et al., “EE2: Adaptive decoder side motion vector refinement (test 3.4)”, in Joint Video Exploration Team (JVET) of ITU-T SG 16 WP 3 and ISO/IEC JTC 1/SC 29/WG 11, 24th Meeting, by teleconference, 6-15 Oct. 2021, Document: JVET-X0049), adaptive decoder side motion vector refinement is disclosed. The adaptive decoder side motion vector refinement method consists of two new merge modes introduced to refine MV only in one direction, either L0 or L1, of the bi-prediction for the merge candidates that meet the DMVR conditions. The multi-pass DMVR process is applied for the selected merge candidate to refine the motion vectors, however either MVD0 or MVD1 is set to zero in the first pass (i.e. PU level) DMVR.

Like the regular merge mode, merge candidates for the proposed merge modes are derived from the spatial neighboring coded blocks, TMVPs (Temporal Motion Vector Predictions), non-adjacent blocks, HMVPs (History-based Motion Vector Predictions), and pair-wise candidate. The difference is that only those meet DMVR conditions are added into the candidate list. The same merge candidate list is used by the two proposed merge modes and merge index is coded as in regular merge mode. There are two syntax elements to indicate this mode, including bmMergeFlag and bmDirFlag. bmMergeFlag is used to indicate the on-off of this kind of prediction (refine MV only on one direction). bmDirFlag is used to indicate the refined MV direction. For example, when bmDirFlag is equal to 0, the refined MV is from List0. When bmDirFlag is equal to 1, the refined MV is from List1. The syntax structure is shown in the following table.

TABLE 1
Syntax structure for bmMergeFlag and bmDirFlag

bm_merge_flag
if (bm_merge_flag)
bm_dir_flag

After decoding bm_merge_flag and bm_dir_flag, bmDir can be decided. For example, if bm_merge_flag is equal to 1 and bm_dir_flag is equal to 0, bmDir will be set as 1. Also, bmDir is used to represent the adaptive MP-DMVR and only refine the MV in List0. For another example, if bm_merge_flag is equal to 1 and bm_dir_flag is equal to 1, bmDir will be set as 2. Also, it is used to represent the adaptive MP-DMVR and only refine the MV in List1.

### Bi-Directional Optical Flow (BIO)/BDOF

Bi-directional optical flow (BIO or BDOF) is motion estimation/compensation technique disclosed in JCTVC-C204 (E. Alshina, et al., Bi-directional optical flow, Joint Collaborative Team on Video Coding (JCT-VC) of ITU-T SG 16 WP 3 and ISO/IEC JTC 1/SC 29/WG 11, 3rd Meeting: Guangzhou, CN, 7-15 Oct. 2010, Document: JCTVC-C204) and VCEG-AZ05 (E. Alshina, et al., Known tools performance investigation for next generation video coding, ITU-T SG 16 Question 6, Video Coding Experts Group (VCEG), 52^{nd} Meeting: 19-26 Jun. 2015, Warsaw, Poland, Document: VCEG-AZ05). BIO derived the sample-level motion refinement based on the assumptions of optical flow and steady motion as shown in FIG. 3, where a current pixel 322 in a B-slice (bi-prediction slice) 320 is predicted by one pixel (332) in reference picture 0 (330) and one pixel (312) in reference picture 1 (310). As shown in FIG. 3, the current pixel 322 is predicted by pixel B 312 in reference picture 1 (310) and pixel A 332 in reference picture 0 (330). In FIG. 3, vₓ and v_{y} are pixel displacement vector in the x-direction and γ-direction, which are derived using a bi-directional optical flow (BIO) model. It is applied only for truly bi-directional predicted blocks, which is predicted from two reference pictures corresponding to the previous picture and the latter picture. In VCEG-AZ05, BIO utilizes a 5×5 window to derive the motion refinement of each sample. Therefore, for an N×N block, the motion compensated results and corresponding gradient information of an (N+4)×(N+4) block are required to derive the sample-based motion refinement for the N×N block. According to VCEG-AZ05, a 6-Tap gradient filter and a 6-Tap interpolation filter are used to generate the gradient information for BIO. Therefore, the computational complexity of BIO is much higher than that of traditional bi-directional prediction. In order to further improve the performance of BIO, the following methods are proposed.

In a conventional bi-prediction in HEVC, the predictor is generated using equation (1), where P⁽⁰⁾ and P⁽¹⁾ are the list0 and list1 predictor, respectively.

$${P}_{Conventional} [ i , j ] = ( {P}^{( 0 )} [ i , j ] + {P}^{( 1 )} [ i , j ] + 1 ) >> 1 \qquad ( 1 )$$

In JCTVC-C204 and VECG-AZ05, the BIO predictor is generated using equation (2).

$${P}_{OpticalFlow} = ( {P}^{( 0 )} [ i , j ] + {P}^{( 1 )} [ i , j ] + {v}_{x} [ i , j ] ( {I}_{x}^{( 0 )} - {I}_{x}^{( 1 )} [ i , j ] ) + {v}_{y} [ i , j ] ( {I}_{y}^{( 0 )} - {I}_{y}^{( 1 )} [ i , j ] ) + 1 ) >> 1 \qquad ( 2 )$$

In equation (2), Iₓ⁽⁰⁾ and Iₓ⁽¹⁾ represent the x-directional gradient in list0 and list1 predictor, respectively; I_{y}⁽⁰⁾ and I_{y}⁽¹⁾ represent the y-directional gradient in list0 and list1 predictor, respectively; vₓ and v_{y} represent the offsets or displacements in x- and y-direction, respectively. The derivation process of vₓ and v_{y} is shown in the following. First, the cost function is defined as diffCost(x, y) to find the best values vₓ and v_{y}. In order to find the best values vₓ and v_{y} to minimize the cost function, diffCost(x, y), one 5×5 window is used. The solutions of vₓ and v_{y} can be represented by using S₁, S₂, S₃, S₅, and S₆.

$$( 3 )$$

$$\begin{matrix}diffCost ( x , y ) = {\sum }_{Ω} ( {P}^{0} ( x , y ) + {v}_{x} \frac{\partial {P}^{0} ( x , y )}{\partial x} + {v}_{y} \frac{\partial {P}^{0} ( x , y )}{\partial y} - \\ {( {P}^{1} ( x , y ) - {v}_{x} \frac{\partial {P}^{1} ( x , y )}{\partial x} - {v}_{y} \frac{\partial {P}^{1} ( x , y )}{\partial y} ) )}^{2} , \\ = {\sum }_{Ω} ( {P}^{0} ( x , y ) - {P}^{1} ( x , y ) + {v}_{x} ( \frac{\partial {P}^{0} ( x , y )}{\partial x} + \frac{\partial {P}^{1} ( x , y )}{\partial x} ) + \\ {{v}_{y} ( \frac{\partial {P}^{0} ( x , y )}{\partial y} + \frac{\partial {P}^{1} ( x , y )}{\partial y} ) )}^{2} .\end{matrix}$$

The minimum cost function, min diffCost(x, y) can be derived according to:

$$\frac{\partial diffCost ( x , y )}{\partial {v}_{x}} = 0 , \frac{\partial diffCost ( x , y )}{\partial {v}_{y}} = 0. \qquad ( 4 )$$

By solving equations (3) and (4), vₓ and v_{y} can be solved according to eqn. (5):

$${v}_{x} = \frac{{S}_{3} {S}_{5} - {S}_{2} {S}_{6}}{{S}_{1} {S}_{5} - {S}_{2} {S}_{2}} , {v}_{y} = \frac{{S}_{1} {S}_{6} - {S}_{3} {S}_{2}}{{S}_{1} {S}_{5} - {S}_{2} {S}_{2}} \qquad ( 5 )$$

where,

$${S}_{1} = {\sum }_{Ω} {( \frac{\partial {P}^{0} ( x , y )}{\partial x} + \frac{\partial {P}^{1} ( x , y )}{\partial x} )}^{2} ,$$

$${s}_{2} = {\sum }_{Ω} ( \frac{\partial {P}^{0} ( x , y )}{\partial x} + \frac{\partial {P}^{1} ( x , y )}{\partial x} ) ( \frac{\partial {P}^{0} ( x , y )}{\partial y} + \frac{\partial {P}^{1} ( x , y )}{\partial y} )$$

$${S}_{3} = - {\sum }_{Ω} ( \frac{\partial {P}^{0} ( x , y )}{\partial x} + \frac{\partial {P}^{1} ( x , y )}{\partial x} ) ( {P}^{0} ( x , y ) - {P}^{1} ( x , y ) ) ,$$

$${S}_{5} = {\sum }_{Ω} {( \frac{\partial {P}^{0} ( x , y )}{\partial y} + \frac{\partial {P}^{1} ( x , y )}{\partial y} )}^{2}$$

$${S}_{6} = - {\sum }_{Ω} ( \frac{\partial {P}^{0} ( x , y )}{\partial y} + \frac{\partial {P}^{1} ( x , y )}{\partial y} ) ( {P}^{0} ( x , y ) - {P}^{1} ( x , y ) ) .$$

We can find that the required bitdepth is large in BIO process, especially for calculating S₁, S₂, S₃, S₅, and S₆. For example, if the bitdepth of pixel value in video sequences is 10 bits and the bitdepth of gradients is increased by fractional interpolation filter or gradient filter, then 16 bits are required to represent one x-directional gradient or one y-directional gradient. These 16 bits may be further reduced by gradient shift equal to 4, so one gradient needs 12 bits to represent the value. Even if the magnitude of gradient can be reduced to 12 bits by gradient shift, the required bitdepth of BIO operations is still large. One multiplier with 13 bits by 13 bits is required to calculate S₁, S₂, and S₅, and another multiplier with 13 bits by 17 bits is required to get S₃, and S₆. When the window size is large, more than 32 bits may be required to represent S₁, S₂, S₃, S₅, and S₆.

In the present invention, methods to improve the coding efficiency related to BDOF are disclosed.

### BRIEF SUMMARY OF THE INVENTION

Method and apparatus of motion vector refinement using bi-directional prediction are disclosed. According to one method of the present invention, input data associated with a current block is received, wherein the input data comprise pixel data for the current block to be encoded at an encoder side or coded data associated with the current block to be decoded at a decoder side. Sample-based displacements for samples in the current block are determined. A combined displacement is determined for a target sample in the current block by combining derived displacements of multiple samples in a region enclosing the target sample. A bidirectional predictor is determined for the current block based on a first predictor derived from a first reference picture in list0, a second predictor derived from a second reference picture in list1, and a refinement term derived using refinement information comprising the combined displacement. The current block is encoded or decoded by using prediction information comprising the bidirectional predictor.

In one embodiment, the target sample is located at a centre of the region. In one embodiment, the combined displacement is calculated as a weighted average of the derived displacements of multiple samples in the region. In one embodiment, larger weights are used for samples in the region closer to the target sample.

In one embodiment, region size is determined based on one or more conditions. In one embodiment, said one or more conditions include current block size. In one embodiment, a larger region size is selected for a larger current block size. In one embodiment, said one or more conditions include prediction mode of the current block. In one embodiment, two blocks having different prediction modes use different region sizes.

In one embodiment, whether to use the combined displacement to refine the bidirectional predictor is indicated by a control flag. In one embodiment, the control flag is signalled or parsed at CU level, slice level, picture level, sequence level, or any combination thereof.

In one embodiment, whether to derive and use the combined displacement for refining the bidirectional predictor is enabled or disabled according to selected reference picture indices, temporal distance between a reference picture and a current picture, quantization parameter, coded information of the current block, prediction mode, motion vectors, motion vector resolution, residual of the current block, reference samples, or any combination thereof.

In one embodiment, a first weight for the first predictor and a second weight for the second predictor are used to derive the bidirectional predictor, and wherein the first weight and the second weight are different. In one embodiment, the first weight and the second weight are also used for first gradients derived based on the first reference picture and second gradients derived based on the second reference picture to derive the refinement term.

In one embodiment, one of a first motion displacement pair and a second motion displacement pair is fixed and a remaining one of the first motion displacement pair and the second motion displacement pair is derived based on the first reference picture or the second reference picture, and wherein the first motion displacement pair and the second motion displacement pair are two motion displacement pairs related to Bi-Directional Optical Flow model associated with the first reference picture and the second reference picture respectively.

In one embodiment, which one of or neither one of the first motion displacement pair and the second motion displacement pair is fixed is derived implicitly according to selected reference pictures indices, temporal distance between a reference picture and a current picture, quantization parameter, coded information of the current block, prediction mode, motion vectors, motion vector resolution, residual of the current block, reference samples, or any combination thereof. In another embodiment, which one of or neither one of the first motion displacement pair and the second motion displacement pair is fixed is explicitly signalled.

In one embodiment, the first motion displacement pair and the second motion displacement pair are derived by taking into consideration of POC (Picture Order Count) distances between a current picture and two respective reference pictures in reference list0 and reference list1.

According to another method, a first predictor is determined based on a first reference picture in list0 and a second predictor is determined based on a second reference picture in list1, wherein both the first reference picture and the second reference picture are before or after a current picture in a display order. A first motion offset is determined for a list 0 reference block associated with the first predictor and a second motion offset is determined for a list 1 reference block associated with the second predictor according to a bidirectional optical flow model. The first motion vector and the second motion vector are refined according to the first motion offset and the second motion offset.

In one embodiment, the method further comprises determining a bi-directional prediction offset value corresponding to a linear combination of the first motion offset for the list 0 reference block and the second motion offset for the list 1 reference block is determined, wherein a same sign is used for the first motion offset and the second motion offset. A bidirectional predictor is derived for the current block based on the first predictor, the second predictor, and the bi-directional prediction offset value.

In one embodiment, the bi-directional prediction offset value is further dependent on POC (Picture Order Count) distances between the current picture and the first reference picture (POC0) and between the current picture and the second reference picture (POC1). In one embodiment, a pair of scaling factors for combining the first motion offset and the second motion offset are proportional to POC0 and POC1.

In one embodiment, a control flag is signalled or parsed to indicate whether to enable using the same sign for the first motion offset and the second motion offset for a case that both the first reference picture and the second reference picture are before or after the current picture in the display order. In one embodiment, the control flag is signalled or parsed at CU (Coding Unit) level, slice level, picture level, sequence level or a combination thereof.

In one embodiment, whether to enable using the same sign for the first motion offset and the second motion offset for a case that both the first reference picture and the second reference picture are before or after the current picture in the display order depends on selected reference picture indices, temporal distance between a reference picture and the current picture, quantization parameter, coded information of the current block, prediction mode, motion vectors, motion vector resolution, residual of the current block, reference samples, or a combination thereof.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the process of Adaptive Decoder side Motion Vector Refinement (Adaptive MP-DMVR.

FIG. 3 illustrates the process of Bi-directional optical flow (BIO) or Bi-Directional Optical Flow (BDOF).

FIG. 4 illustrates an exemplary flowchart of a video coding system using Bi-Directional Optical Flow (BDOF) to refine bi-direction prediction according to an embodiment of the present invention.

FIG. 5 illustrates an exemplary flowchart of a video coding system using Bi-Directional Optical Flow (BDOF) to refine bi-direction prediction for both reference pictures being before or after the current picture according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Scheme 1: BDOF with BCW

In one embodiment, BDOF can be applied on non-equal weight bi-prediction.

In one embodiment, non-equal weights of BCW can be considered during BDOF motion displacement derivation. The parameters of BDOF derived from the side with larger BCW weights can be multiplied with larger weights before displacement derivation. For example, if the BCW weight for L0 is w0, and the weight for L1 is w1. After gradX0, and gradY0 are derived, they will be multiplied by w0 before further calculation. After gradX1, and gradY1 are derived, they will be multiplied by w1 before further calculation.

In one embodiment, non-equal weights of BCW can be considered during BDOF motion displacement derivation. The parameters of BDOF derived from the side with larger BCW weights can be multiplied with smaller weights before displacement derivation. For example, if the BCW weight for L0 is w0, and the weight for L1 is w1. After gradX0, and gradY0 are derived, they will be multiplied by w1 before further calculation. After gradX1, and gradY1 are derived, they will be multiplied by w0 before further calculation.

In one embodiment, non-equal weights of BCW and the POC distances between the current picture and reference L0 and between the current picture and reference picture L1 can be considered together during BDOF motion displacement derivation. For example, two weights are derived based on non-equal weights of BCW and the POC distance between the current picture and reference L0 and between the current picture and reference picture L1. The first weight will be multiplied with gradX0 and gradY0 before further calculation. The second weight will be multiplied with gradX1 and gradY1 before further calculation.

In one embodiment, non-equal weights of BCW can be considered during BDOF predictor blending process. In traditional BDOF bi-prediction blending process, the following formula is used.

$$P 0 + P 1 + vx * ( gradX 0 - gradX 1 ) + vy * ( gradY 0 - gradY 1 ) ,$$

where P0 and P1 is two predictors for L0 and L1 respectively, and (vx, vy) is one two-dimensional motion displacement derived by BDOF algorithm.

For example, when non-equal weight of BCW is applied, weight for L0 is w0 and weight for L1 is w1, the following blending formula can be used.

$$w 0 * P 0 + w 1 * P 1 + vx * ( w 1 * gradX 0 - w 0 * gradX 1 ) + vy * ( w 1 * gradY 0 - w 0 * gradY 1 ) .$$

For another example, when non-equal weight of BCW is applied, weight for L0 is w0 and weight for L1 is w1, the following blending formula can be used.

$$w 0 * P 0 + w 1 * P 1 + vx * ( w 0 * gradX 0 - w 1 * gradX 1 ) + vy * ( w 0 * gradY 0 - w 1 * gradY 1 ) .$$

For another example, when non-equal weight of BCW is applied, weight for L0 is w0 and weight for L1 is w1, the following blending formula can be used.

$$w 0 * P 0 + w 1 * P 1 + vx * ( a * gradX 0 - b * gradX 1 ) + vy * ( a * gradY 0 - b * gradY 1 ) ,$$

where a, and b are two weighting parameters derived based on BCW non-equal weights. Also, a and b can be two weighting parameters derived based on POC distances between the current picture and reference picture L0 and between the current picture and reference picture L1 respectively.

In another embodiment, one on/off control flag is signalled at CU level, slice level, picture level, and/or sequence level to indicate whether the proposed method in the above is enabled or not.

In another embodiment, the proposed method in the above is enabled or disabled, according to one or a combination of the selected reference pictures indices, temporal distance between the reference picture and the current picture, quantization parameter, the coded information of the current CU, prediction mode, motion vectors, motion vector resolution, residual of the current CU, and reference samples.

### Scheme 2: Decoupling BDOF Motion Displacements

In one embodiment, two motion displacement pairs can be derived in BDOF process, where one motion pair (vx0, vy0) is used to refine list0 motion and the other motion pair (vx1, vy1) is used to refine list1 motion. There is no constraint for the signs of (vx0, vy0), and (vx1, vy1).

In one embodiment, one regression-based method is applied to derive BDOF motion displacements. Motion displacements (i.e., vx0, vy0, vx1, vy1) are 4 parameters needed to be determined. The inputs of the regression model of BDOF are x-axis gradient value and y-axis gradient of list0 and list1. The derivation formula is shown below.

$$P 1 - P 0 = gradX 0 * vx 0 + gradY 0 * vy 0 + gradX 1 * vx 1 + gradY 1 * vy 1 ,$$

where P0 and P1 are two predictors for L0 and L1 respectively.

It can be re-formula as following:

$$Ax = b ,$$

$$[ \begin{matrix}\sum {X}_{0}^{2} & \sum {X}_{0} {X}_{1} & \sum {X}_{0} {X}_{2} & \sum {X}_{0} {X}_{3} \\ \sum {X}_{0} {X}_{1} & \sum {X}_{1}^{2} & \sum {X}_{1} {X}_{2} & \sum {X}_{1} {X}_{3} \\ \sum {X}_{1} {X}_{3} & \sum {X}_{1} {X}_{2} & \sum {X}_{2}^{2} & \sum {X}_{2} {X}_{3} \\ \sum {X}_{0} {X}_{3} & \sum {X}_{0} {X}_{2} & \sum {X}_{0} {X}_{1} & \sum {X}_{3}^{2}\end{matrix} ] [ \begin{matrix}a \\ b \\ c \\ d\end{matrix} ] = [ \begin{matrix}\sum {yX}_{0} \\ \sum {yX}_{1} \\ \sum {yX}_{2} \\ \sum {yX}_{3}\end{matrix} ] ,$$

where {a, b, c, d} represents {vx0, vy0, vx1, vy1}, {X0, X1, X2, X3} represents {gradX0, gradY0, gradX1, gradY1, }, and y represents the difference between predictors L0 and L1 (i.e., (P1-P0)).

In one embodiment, Gaussian elimination can be used to derive a, b, c, and d.

In one embodiment, a regularization term can be added to make vx0 and vx1 closer and make vy0 and vy1 closer. For example, a regularization term is added on all diagonal terms of matrix A. The regularization terms are associated with the strength of the constraints.

In one embodiment, a regulation term can be added to make vx0 and −vx1 closer and make vy0 and −vy1 closer. For example, a regularization term is added on all diagonal terms of matrix A. The regularization terms are associated with the strength of the constraints.

In one embodiment, the strength of the similarity of vx0 and −vx1 and the strength of the similarity of vy0 and −vy1 can be different or the same.

In one embodiment, the regularization term related to the similarity of vx0 and −vx1 and the similarity of vy0 and −vy1 can be determined by the first elements in matrix A

$$( i . e . , \sum {X}_{0}^{2} * 0.05 )$$

In one embodiment, the regularization term related to the similarity of vx0 and −vx1 and the similarity of vy0 and −vy1 can be derived by right shifting by N bits of one element in matrix A

$$( e . g . , \sum {X}_{0}^{2} >> N ) .$$

N can be any integer larger than 0.

In one embodiment, the regularization can be designed based on the bit-depth of the current picture, the current coded mode, or QP of the current block.

In another embodiment, the regularization term is dependent on one or a combinations of the temporal distances between the selected reference pictures and the current picture respectively, motion vectors, the difference/similarity between two motion vectors, the coded information of the current CU, motion vector resolution, residual of current CU, quantization parameter, and prediction mode.

In one embodiment, BDOF first motion displacements can be derived by an optical flow algorithm and Taylor's expansion. After that, the regression method is used to derived second motion displacements, where a regularization term is added to constrain the difference between the first motion displacements and second motion displacements. For example, a regularization term is added on all diagonal terms of matrix A and other regularization term is added on each element of vector b. Two regularization terms are associated with the strength of the related constraints.

Scheme 3: One-Side BDOF Refinement/BDOF with Non-Equal Distance Displacements Derivation

In one embodiment, the BDOF motion displacement can be derived under the condition that either MV0 or MV1 is fixed. The derived motion displacement can be applied to non-fixed MV or both of the MV0 and MV1.

For example, we consider that MV0 is fixed, and then derive the BDOF motion displacement

$$( {v}_{x}^{′} , {v}_{y}^{′} ) .$$

The motion displacement is applied to MV1 only. The formula can be shown in the following equation.

$$P 0 + P 1 + {v}_{x}^{′} * ( - gradX 1 ) + {v}_{y}^{′} * ( - gradY 1 ) .$$

In another embodiment, which one of or neither of the MVs is fixed is derived implicitly according to one or a combination of the selected reference pictures indices, temporal distance between the reference picture and the current picture, quantization parameter, the coded information of the current CU, prediction mode, motion vectors, motion vector resolution, residual of the current CU, and reference samples.

In another embodiment, which MV is fixed or neither of the MVs is explicitly signalled directly by the encoder.

In one embodiment, the BDOF motion displacement is derived using the traditional method. However, the derived motion displacement can be applied to MV0, MV1, or both MVs.

For example, the derived BDOF motion displacement (vₓ, v_{y}) using traditional method can be applied to MV0 only, and the formula can be as follows

$$P 0 + P 1 + {v}_{x} * ( gradX 0 ) + {v}_{y} * ( gradY 0 ) .$$

In another embodiment, which MV is applied or both MVs can be implicitly derived or explicitly signalled.

In one embodiment, the BDOF motion displacement is derived with the POC distances between the current picture and two respective reference list considered. In traditional BDOF, the POC distances are assumed to be equal, and the derived motion displacement is applied to MV0 and MV1 with same magnitude. With the POC distances considered, the BDOF derived motion displacement can be applied to MV0 and MV1 with scaling factor pair (a, b) which is proportional to the POC distances. The equation can be as follows.

$$P 0 + P 1 + vx * ( a * gradX 0 - b * gradX 1 ) + vy * ( a * gradY 0 - b * gradY 1 ) .$$

### Scheme 4: Same Sign of BDOF MV Refinements for L0 and L1

In one embodiment, BDOF can be applied under non-true-bi condition. In VVC, BDOF is disabled when both reference list0 and list1 are smaller or greater than the current picture in display order. To enable non-true-bi condition, the BDOF motion displacement can be applied to MV0 and MV1 with same sign. The equation can be as follows,

$$P 0 + P 1 + vx * ( gradX 0 + g r adX 1 ) + vy * ( gradY 0 + gradY 1 ) .$$

In another embodiment, the POC distances between the current picture and two respective reference list are further considered. The equation can be as follows, where the scaling factor pair (a, b) is proportional to the POC distances.

$$P 0 + P 1 + vx * ( a * gradX 0 + b * gradX 1 ) + vy * ( a * gradY 0 + b * gradY 1 ) .$$

In another embodiment, one on/off control flag is signalled at CU level, slice level, picture level, and/or sequence level to indicate whether the proposed method in the above is enabled or not.

In another embodiment, the proposed method in the above is enabled or disabled according to one or a combination of the selected reference picture indices, temporal distance between the reference picture and the current picture, quantization parameter, the coded information of current CU, prediction mode, motion vectors, motion vector resolution, residual of the current CU, and reference samples.

### Scheme 5: BDOF Displacements Fusion

In one embodiment, the final displacement for a sample is the averaged displacement calculated by displacements of N samples within a region after sample-based displacements of a CU are derived.

For example, a sample is the centre of a region. The final displacement of the sample is obtained from averaging the derived sample-based displacements of all samples within the region.

For another example, a sample is included in a region regardless whether it is the centre of the region or not. The final displacement of the sample is obtained from averaging the derived sample-based displacements of all samples within the region.

In one embodiment, the final displacement for a sample is the weighted averaging displacement calculated by N samples' displacements after sample-based displacements of a CU are derived.

For example, a sample is the centre of a region. Larger weighting values are for the samples which are closer to the centre of the region; smaller weighting values are for the samples which are farther from the centre of the region. The final displacement of the sample is obtained by weighted averaging the derived sample-based displacements of samples within the region.

For another example, a sample is included in a region whether it is the centre of the region or not. Larger weighting values are for the samples which are closer to the operating sample; smaller weighting values are for the samples which are farther from the operating sample. The final displacement of the operating sample is obtained by weighted averaging the derived sample-based displacements of samples within the region.

In one embodiment, the region size can be designed based on different criteria. For example, the region size is related to the CU size. A larger size of the region is given when the size of CU is larger; a smaller size of the region is given when the size of CU is smaller.

For another example, the region size is related to the prediction mode. When different prediction modes are selected, the region sizes can be different.

In another embodiment, one on/off control flag is signalled at CU level, slice level, picture level, and/or sequence level to indicate the proposed method in the above is enabled or not.

In another embodiment, the proposed method in the above is enabled or disabled according to one or a combination of the selected reference pictures indices, temporal distance between the reference picture and the current picture, quantization parameter, the coded information of the current CU, prediction mode, motion vectors, motion vector resolution, residual of the current CU, and reference samples.

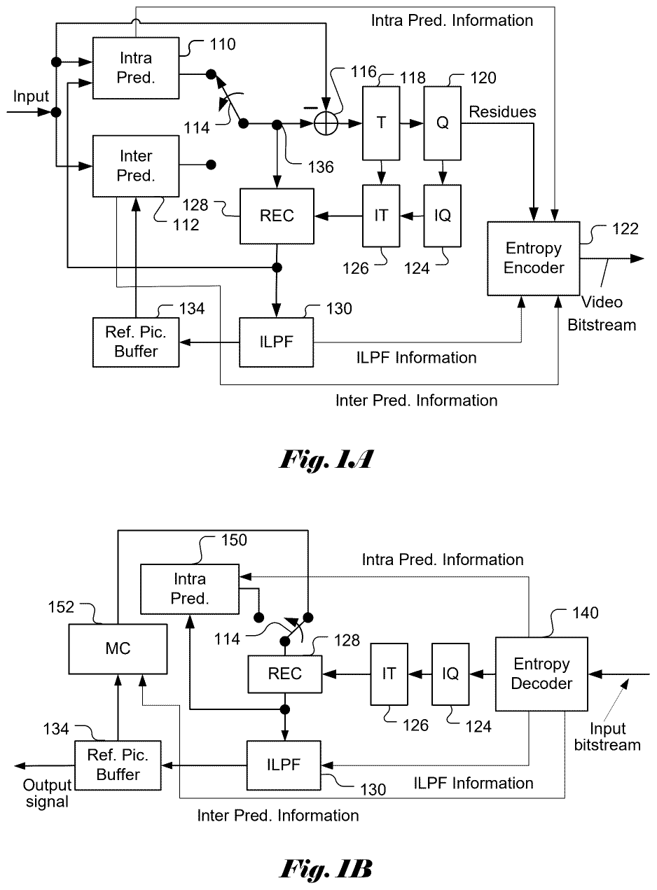

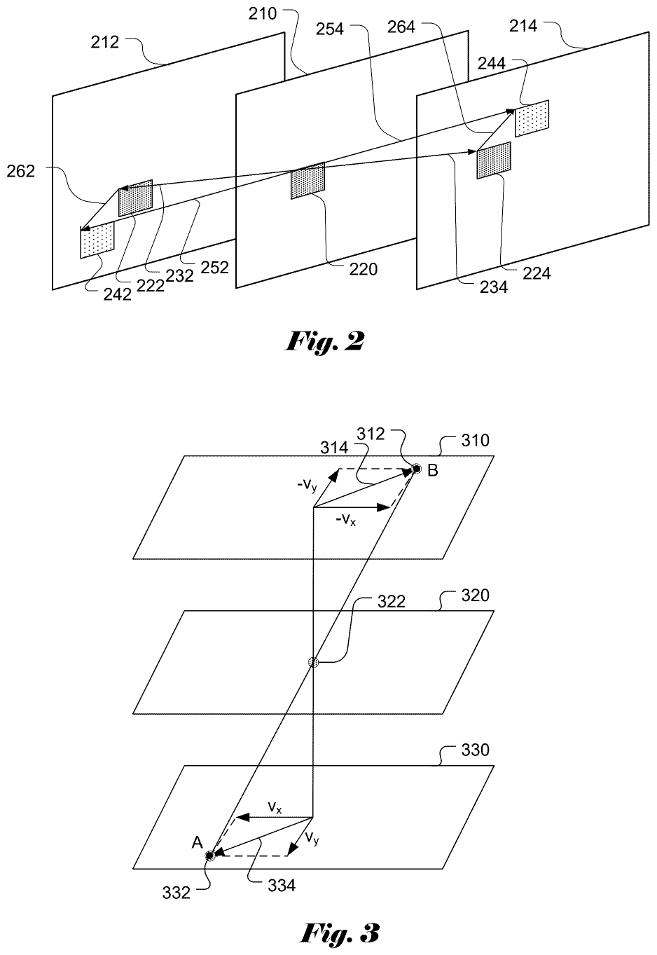

Any of the foregoing proposed bi-directional prediction methods can be implemented in an inter/intra/prediction module of an encoder, and/or an inter/intra/prediction module of a decoder. For example, in the encoder side, the motion displacement pair derivation for bi-directional Optical Flow (BDOF) can be implemented as part of the Inter-Pred. unit 112 FIG. 1A. However, the encoder may also use additional processing unit to implement the required processing. For the decoder side, the required motion displacement pair derivation can be implemented as part of the MC unit 152 as shown in FIG. 1B. However, the decoder may also use additional processing unit to implement the required processing. Alternatively, any of the proposed methods can be implemented as a circuit coupled to the inter/intra/prediction module of the encoder and/or the inter/intra/prediction module of the decoder, so as to provide the information needed by the inter/intra/prediction module. While the Inter-Pred. 112 in the encoder side and MC 152 in the decoder side are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

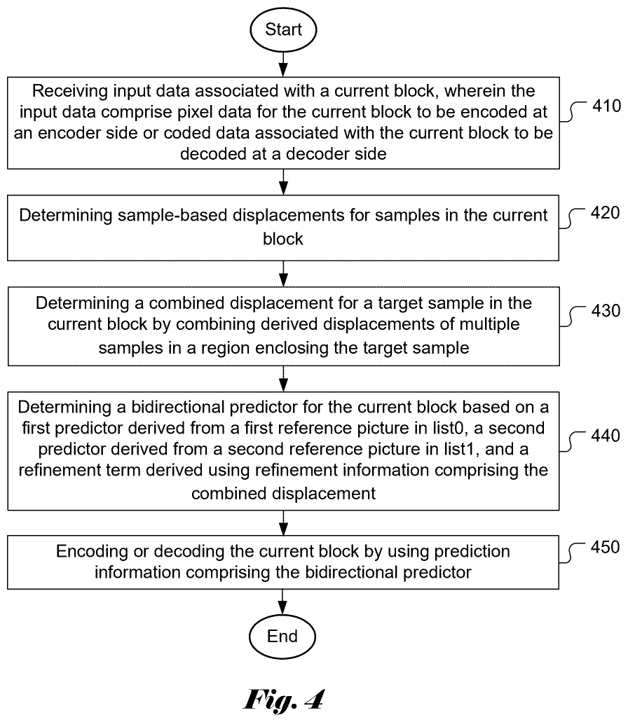

FIG. 4 illustrates an exemplary flowchart of a video coding system using Bi-Directional Optical Flow (BDOF) to refine bi-direction prediction according to an embodiment of the present invention. The steps shown in the flowchart, as well as other flowcharts in this disclosure, may be implemented as program codes executable on one or more processors (e.g., one or more CPUs) at the encoder side and/or the decoder side. The steps shown in the flowchart may also be implemented based on hardware such as one or more electronic devices or processors arranged to perform the steps in the flowchart. According to this method, input data associated with a current block is received in step 410, wherein the input data comprise pixel data for the current block to be encoded at an encoder side or coded data associated with the current block to be decoded at a decoder side. Sample-based displacements for samples in the current block are determined in step 420. A combined displacement is determined in step 430 for a target sample in the current block by combining derived displacements of multiple samples in a region enclosing the target sample. A bidirectional predictor is determined in step 440 for the current block based on a first predictor derived from a first reference picture in list0, a second predictor derived from a second reference picture in list1, and a refinement term derived using refinement information comprising the combined displacement. The current block is encoded or decoded by using prediction information comprising the bidirectional predictor in step 450.

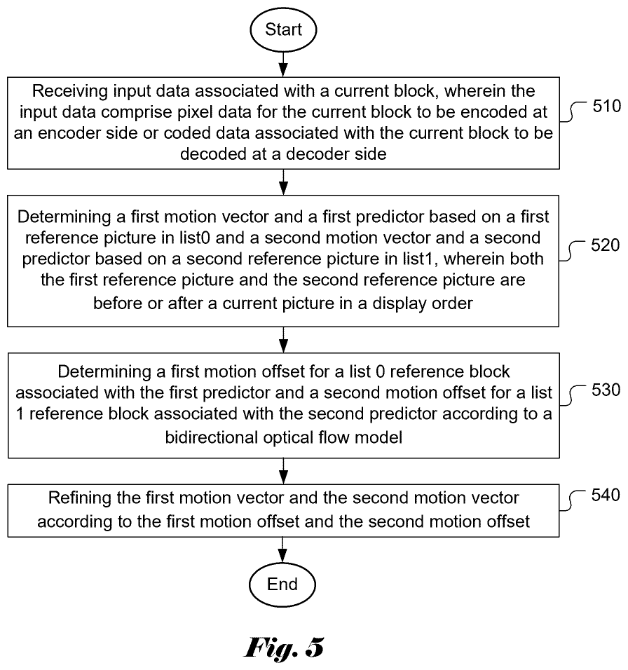

FIG. 5 illustrates an exemplary flowchart of a video coding system using Bi-Directional Optical Flow (BDOF) to refine bi-direction prediction for both reference pictures being before or after the current picture according to an embodiment of the present invention. According to this method, input data associated with a current block is received in step 510, wherein the input data comprise pixel data for the current block to be encoded at an encoder side or coded data associated with the current block to be decoded at a decoder side. A first motion vector and first predictor are determined based on a first reference picture in list0 and a second motion vector and a second predictor are determined based on a second reference picture in list1 in step 520, wherein both the first reference picture and the second reference picture are before or after a current picture in a display order. A first motion offset is determined for a list 0 reference block associated with the first predictor and a second motion offset is determined for a list 1 reference block associated with the second predictor according to a bidirectional optical flow model in step 530. The first motion vector and the second motion vector are refined according to the first motion offset and the second motion offset in step 540.

The flowcharts shown above are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or coded data associated with the current block to be decoded at a decoder side;
determining sample-based displacements for samples in the current block;
determining a combined displacement for a target sample in the current block by combining derived displacements of multiple samples in a region enclosing the target sample;
determining a bidirectional predictor for the current block based on a first predictor derived from a first reference picture in list0, a second predictor derived from a second reference picture in list1, and a refinement term derived using refinement information comprising the combined displacement; and
encoding or decoding the current block by using prediction information comprising the bidirectional predictor.

2. The method of claim 1, wherein the target sample is located at a centre of the region.

3. The method of claim 1, wherein the combined displacement is calculated as a weighted average of the derived displacements of multiple samples in the region.

4. The method of claim 3, wherein larger weights are used for samples in the region closer to the target sample.

5. The method of claim 1, wherein region size is determined based on one or more criteria.

6. The method of claim 5, wherein said one or more criteria include current block size.

7. The method of claim 6, wherein a larger region size is selected for a larger current block size.

8. The method of claim 5, wherein said one or more criteria include prediction mode of the current block.

9. The method of claim 8, wherein two blocks having different prediction modes use different region sizes.

10. The method of claim 1, wherein whether to use the combined displacement to refine the bidirectional predictor is indicated by a control flag.

11. The method of claim 10, wherein the control flag is signalled or parsed at CU level, slice level, picture level, sequence level, or any combination thereof.

12. The method of claim 1, wherein whether to derive and use the combined displacement for refining the bidirectional predictor is enabled or disabled according to selected reference picture indices, temporal distance between a reference picture and a current picture, quantization parameter, coded information of the current block, prediction mode, motion vectors, motion vector resolution, residual of the current block, reference samples, or any combination thereof.

13. The method of claim 1, wherein a first weight for the first predictor and a second weight for the second predictor are used to derive the bidirectional predictor.

14. The method of claim 13, wherein the first weight and the second weight are also used for first gradients derived based on the first reference picture and second gradients derived based on the second reference picture to derive the refinement term.

15. The method of claim 13, wherein the first weight and the second weight are different respectively from a third weight for first gradients derived based on the first reference picture and a fourth weight for second gradients derived based on the second reference picture to derive the refinement term.

16. The method of claim 1, wherein one of a first motion displacement pair and a second motion displacement pair is fixed and a remaining one of the first motion displacement pair and the second motion displacement pair is derived based on the first reference picture or the second reference picture, and wherein the first motion displacement pair and the second motion displacement pair are two motion displacement pairs related to Bi-Directional Optical Flow model associated with the first reference picture and the second reference picture respectively.

17. The method of claim 16, wherein which one of or neither one of the first motion displacement pair and the second motion displacement pair is fixed is derived implicitly according to selected reference pictures indices, temporal distance between a reference picture and a current picture, quantization parameter, coded information of the current block, prediction mode, motion vectors, motion vector resolution, residual of the current block, reference samples, or any combination thereof.

18. The method of claim 16, wherein which one of or neither one of the first motion displacement pair and the second motion displacement pair is fixed is explicitly signalled.

19. The method of claim 16, wherein the first motion displacement pair and the second motion displacement pair are derived by taking into consideration of POC (Picture Order Count) distances between a current picture and two respective reference pictures in in reference list0 and reference list1.

20. An apparatus for video coding, the apparatus comprising one or more electronics or processors arranged to:
receive input data associated with a current block, wherein the input data comprise pixel data for the current block to be encoded at an encoder side or coded data associated with the current block to be decoded at a decoder side;
determine sample-based displacements for samples in the current block;
determine a combined displacement for a target sample in the current block by combining derived displacements of multiple samples in a region enclosing the target sample;
determine a bidirectional predictor for the current block based on a first predictor derived from a first reference picture in list0, a second predictor derived from a second reference picture in list1, and a refinement term derived using refinement information comprising the combined displacement; and
encode or decode the current block by using prediction information comprising the bidirectional predictor.

21. A method of video coding, the method comprising:
receiving input data associated with a current block, wherein the input data comprise pixel data for the current block to be encoded at an encoder side or coded data associated with the current block to be decoded at a decoder side;
determining a first motion vector and a first predictor based on a first reference picture in list0 and a second motion vector and a second predictor based on a second reference picture in list1, wherein both the first reference picture and the second reference picture are before or after a current picture in a display order;
determining a first motion offset for a list 0 reference block associated with the first predictor and a second motion offset for a list 1 reference block associated with the second predictor according to a bidirectional optical flow model; and
refining the first motion vector and the second motion vector according to the first motion offset and the second motion offset.

22. The method of claim 21, further comprising:
determining a bi-directional prediction offset value corresponding to a linear combination of the first motion offset for the list 0 reference block and the second motion offset for the list 1 reference block, wherein a same sign is used for the first motion offset and the second motion offset; and
deriving a bidirectional predictor for the current block based on the first predictor, the second predictor, and the bi-directional prediction offset value.

23. The method of claim 22, wherein the bi-directional prediction offset value is further dependent on POC (Picture Order Count) distances between the current picture and the first reference picture (POC0) and between the current picture and the second reference picture (POC1).

24. The method of claim 23, wherein a pair of scaling factors for combining the first motion offset and the second motion offset are proportional to POC0 and POC1.

25. The method of claim 22, wherein a control flag is signalled or parsed to indicate whether to enable using the same sign for the first motion offset and the second motion offset for a case that both the first reference picture and the second reference picture are before or after the current picture in the display order.

26. The method of claim 25, wherein the control flag is signalled or parsed at CU (Coding Unit) level, slice level, picture level, sequence level or a combination thereof.

27. The method of claim 22, wherein whether to enable using the same sign for the first motion offset and the second motion offset for a case that both the first reference picture and the second reference picture are before or after the current picture in the display order depends on selected reference picture indices, temporal distance between a reference picture and the current picture, quantization parameter, coded information of the current block, prediction mode, motion vectors, motion vector resolution, residual of the current block, reference samples, or a combination thereof.
